(19) United States
(12) Patent Application Publication
(10) Pub. No.: US 2009/0095326 A1
(43) Pub. Date: Apr. 16, 2009

(54) Apparatus and method for treating substrate

(76) Inventors: Hyo-Jun An, Chungcheongnam-do (KR); Gui-Su Park, Chungcheongnam-do (KR)

Correspondence Address: JENKINS, WILSON, TAYLOR & HUNT, P. A., Suite 1200 UNIVERSITY TOWER, 3100 TOWER BLVD.,, DURHAM, NC, 27707, US

(21) Appl. No.: 12/287,518

(22) Filed: Oct. 10, 2008

(30) Foreign Application Priority Data
Oct. 10, 2007 (KR) 2007-101881

(51) Int. Cl. B08B 3/04

(52) U.S. Cl. 134/26; 134/61

(57) ABSTRACT

Provided are an apparatus for cleaning a substrate by dipping the substrate in a treating bath filled with a treating solution and a method for cleaning a substrate using the apparatus. A boat provided to each of the treating baths supports the substrate by being in contact with a different point of a substrate during a process. Contact points of the substrate which each of the boats supports are made different at every treating bath, so that contact points of a substrate which are not cleaned in any treating bath can be cleaned in different treating baths. Therefore, an efficiency of a cleaning process is improved.

### CROSS-REFERENCE TO RELATED APPLICATION

This U.S. non-provisional patent application claims priority under 35 U.S.C. §119 of Korean Patent Application No. 10-2007-0101881, filed on Oct. 10, 2007, the entire contents of which are hereby incorporated by reference.

### BACKGROUND OF THE INVENTION

The present invention disclosed herein relates to apparatuses and methods for treating substrates, and more particularly, to an apparatus for treating a substrate using a treating bath which cleans a wafer by dipping the wafer into the treating bath filled with a treating solution and a method for treating a substrate using the apparatus.

A process of manufacturing a semiconductor device includes a cleaning process that removes various foreign substances such as a corpuscle metal impurity, an organic pollutant and a surface film from a semiconductor wafer. A batch type wafer cleaning apparatus among the apparatuses performing a cleaning process includes a substrate cleaning unit. The substrate cleaning unit is a unit that performs a wafer cleaning. The substrate cleaning unit includes a plurality of treating baths. The treating baths have roughly the same structure and are adjacently disposed. Treating solution is supplied to each of the treating baths through a supplying line and stored in each of the treating baths. When wafers are cleaned, the wafers are cleaned by dipping the wafers into the treating solution that is stored in the treating bath.

However, a cleaning efficiency of a wafer in a cleaning apparatus having the structure described above may be deteriorated due to a supporting member that supports a wafer during a cleaning process. Wafers dipped in the treating bath are disposed on the supporting member and supported by the supporting member during the cleaning process. At this time, a portion of the wafer which is in contact with the supporting member is not cleaned by a treating solution in the treating bath. As a result, an efficiency of a wafer treating process may be deteriorated when a subsequent process is performed.

### SUMMARY OF THE INVENTION

Some embodiments provide an apparatus for cleaning a substrate. The apparatus includes a first treating bath that includes a first housing having a space that is filled with a treating solution and a first supporting member that supports a substrate in the first housing during a process, a second treating bath that includes a second housing having a space that is filled with a treating solution and a second supporting member that supports the substrate in the second housing during a process, and a transferring portion that transfers the substrate to the first treating bath and the second treating bath, wherein the first supporting member and the second supporting member are shaped so that points that the first and second supporting members are in contact with the substrate are different during a process.

Some embodiments provided a method for cleaning a substrate. The method is that a substrate is cleaned using treating baths that clean the substrate by dipping the substrate in a treating solution, wherein at least two of the treating baths clean the substrate by supporting different points of the substrate dipped in the treating solution.

### BRIEF DESCRIPTION OF THE FIGURES

The accompanying figures are included to provide a further understanding of the present invention, and are incorporated in and constitute a part of this specification. The drawings illustrate exemplary embodiments of the present invention and, together with the description, serve to explain principles of the present invention. In the figures:

FIG. 1 is a top plan view of an apparatus for treating a substrate in accordance with the present invention.

FIG. 2 is a front view of a wafer cleaning unit depicted in FIG. 1.

FIG. 3 is a side view of a wafer cleaning unit depicted in FIG. 1.

FIG. 4 is a perspective view of a boat depicted in FIG. 3.

FIG. 5 is a flow chart illustrating a method for treating a substrate in accordance with the present invention.

FIGS. 6 to 10 are drawings describing a process for cleaning a substrate in accordance with the present invention.

### DETAILED DESCRIPTION OF PREFERRED EMBODIMENTS

The present invention now will be described more fully hereinafter with reference to the accompanying drawings, in which embodiments of the invention are shown. This invention may, however, be embodied in many different forms and should not be construed as limited to the embodiments set forth herein. Rather, these embodiments are provided so that this disclosure will be thorough and complete, and will fully convey the scope of the invention to those skilled in the art. In the drawings, the size and relative sizes of layers and regions may be exaggerated for clarity. Like numbers refer to like elements throughout.

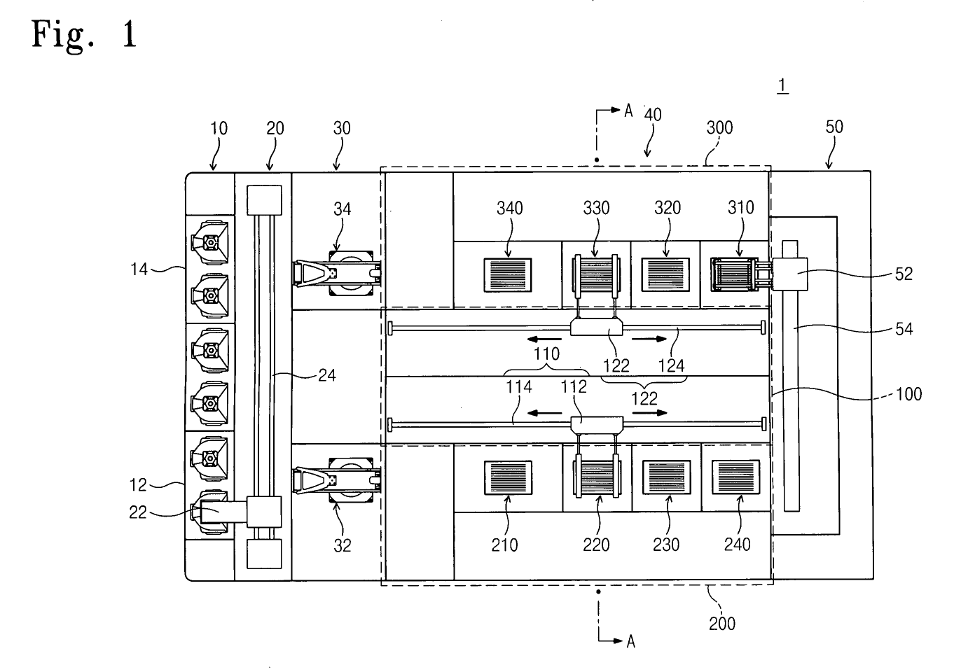

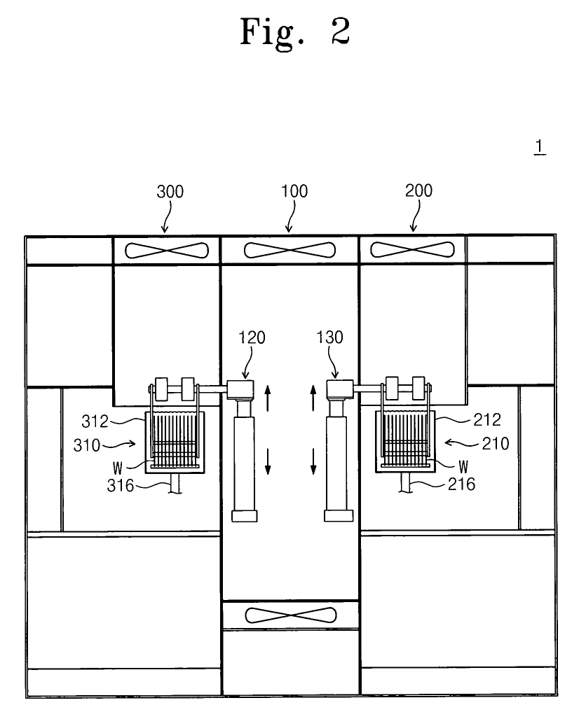

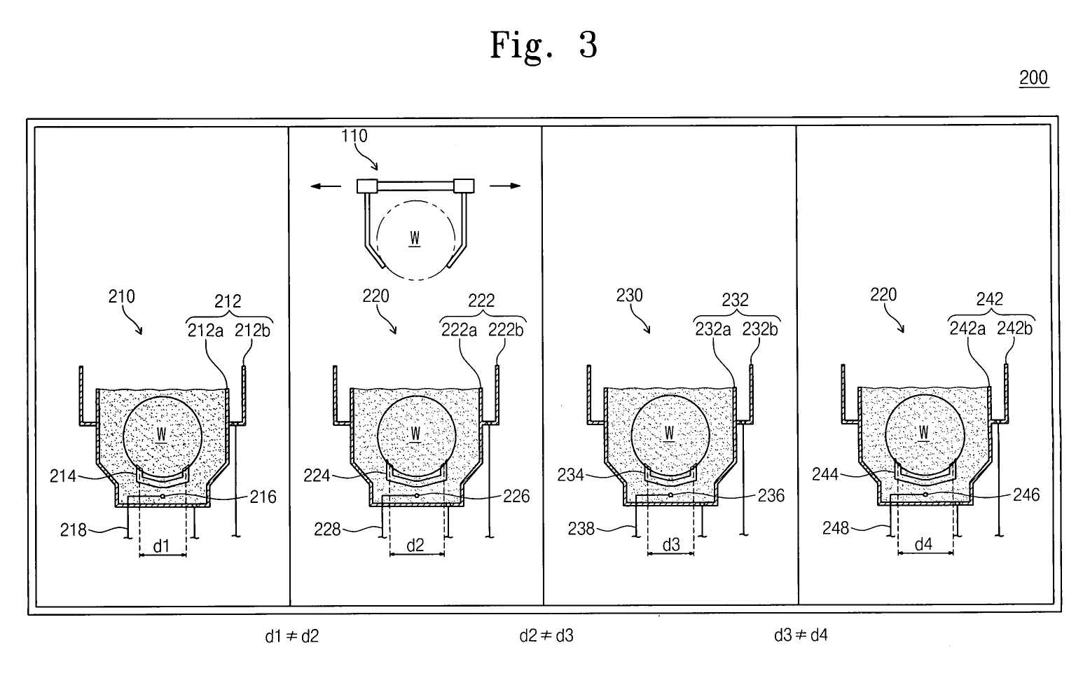

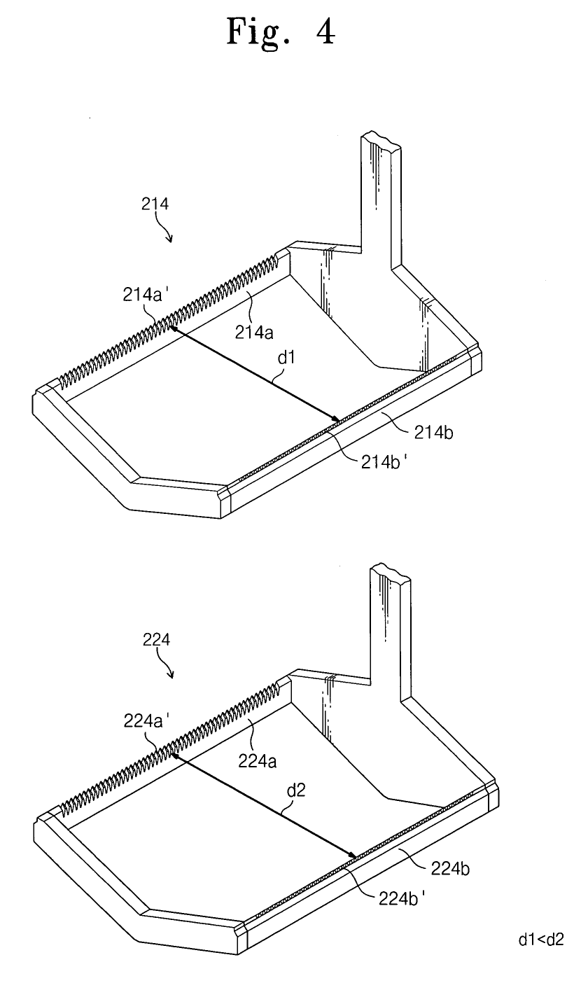

FIG. 1 is a top plan view of an apparatus for treating a substrate in accordance with the present invention and FIG. 2 is a front view of a wafer cleaning unit depicted in FIG. 1. FIG. 3 is a side view of a wafer cleaning unit depicted in FIG. 1 and FIG. 4 is a perspective view of a wafer cleaning unit depicted in FIG. 3.

Referring to FIG. 1, an apparatus 1 for treating a substrate performs a process for treating a semiconductor substrate (hereinafter, it is referred to as a wafer). The apparatus 1 for treating a substrate includes a cassette treating unit, a first wafer transferring unit 30, a wafer cleaning unit 40 and a second wafer transferring unit 50.

The cassette treating unit treats a member (hereinafter, it is referred as cassette) receiving a plurality of wafers. A stocker unit is used as the cassette treating unit. The stocker unit includes a cassette receiving portion 10 and a cassette transferring portion 20. A plurality of cassettes C are transferred to the cassette receiving portion 10 and the cassette receiving portion 10 receives the plurality of cassettes. The cassette receiving portion 10 includes a carrying in portion 12 that carries the cassettes C in the cassette receiving portion 10 and a carrying out portion 14 that carries the cassettes C out of the cassette receiving portion 10. The cassettes C are two dimensionally loaded along rows and columns of the cassette receiving portion 10.

The cassette transferring portion 20 transfers cassettes C that are disposed in the cassette receiving portion 10 to the first wafer transferring unit 30. The cassette transferring portion 20 includes at least one transfer arm 22. The transferring arm 22 moves cassettes C disposed on a plate 16 of the cassette receiving portion 10 to a position that robot arms 32 and 34 of the first wafer transferring unit 30 treat wafers disposed in the cassettes. The transfer arm 22 moves linearly back and force along a guide rail 24 and goes to a position for treating a cassette that is required to be processed among the cassettes disposed in the cassette receiving portion 10.

The first wafer transferring unit 30 transfers wafers W between the cassette treating unit and the wafer cleaning unit 40. The first wafer transferring unit 30 includes a first robot arm 32 and a second robot arm 34. The first robot arm 32 transfers wafers W from the cassette treating unit to the wafer cleaning unit 40 and the second robot arm 34 transfers wafers W that a cleaning process is completed from the cleaning unit 40.

A substrate cleaning unit 40 performs a process of cleaning wafers W. The substrate cleaning unit 40 (hereinafter, it is referred to as wafer cleaning unit) includes a transferring portion 100, a first cleaning portion 200 and a second cleaning portion 300. The first cleaning portion 200 and the second cleaning portion 300 are disposed both sides of the transferring portion 100. The first and second cleaning portions 200 and 300 are disposed in parallel along a length direction of the apparatus 1. Each of the first cleaning portion 200 and the second cleaning portion 300 includes a plurality of treating baths.

The second wafer transferring unit 50 transfers wafers W from the first cleaning portion 200 to the second cleaning portion 300. The second wafer transferring unit 50 includes a third robot arm 52 and a guide rail 54. The third robot arm 52 moves along the guide rail 54. The third robot arm 52 linearly moves back and forth along the guide rail 54. The third robot arm 52 receives wafers W that a cleaning process is completed and transfers the wafers W to the second cleaning portion 300.

Referring to FIGS. 2 and 3, the transferring portion 100 transfers wafers W to the first and second cleaning portions 200 and 300. The transferring portion 100 includes a first robot arm 110 and second robot arm 120. The first robot arm 110 includes a first arm 112 and a guide rail 114. The first arm 112 moves along the guide rail 114 and transfers wafers W to each of the treating baths of the first cleaning portion 200. In the same manner, the second robot arm 120 includes a second arm 122 and a guide rail 124. The second arm 122 moves along the guide rail 124 and transfers wafers W to each of the treating baths of the second cleaning portion 300.

The first and second cleaning portions 200 and 300 perform a process of cleaning wafers W. The first and second cleaning portions 200 and 300 include a plurality of treating baths. Each of the treating baths cleans wafers W using a treating solution. At this time, each of the treating baths may use a different solution or the same treating solution.

In an embodiment, each of the first and second cleaning portions 200 and 300 includes four treating baths. The treating baths included in the first cleaning portion 200 and the second cleaning portions 300 are disposed in a line and treating solution used in each of the treating baths may be different. All the treating baths or a portion of the treating baths may use the same treating solution. In the present embodiment, the treating baths in the first cleaning portion 200 are referred to as first through four treating baths 210, 220, 230 and 240 and the treating baths in the second cleaning portion 300 are referred to as fifth through eighth treating baths. However, the first through eighth treating baths 210, 220, 230, 240, 310, 320, 330 and 340 may be diversely disposed.

Each treating bath has roughly the same constitution and structure but a structure of a supporting member (hereinafter, it is referred to as boat) supporting wafers W is different. Therefore, in the present embodiment, constitutions of the first treating bath 210 are described in detail and the boats of the second through eighth treating baths 220, 230, 240, 310, 320, 330 and 340 are described.

The first treating bath 210 includes a first housing 212, a first boat 214, a first injection nozzle 216 and a first supply line 218. The first housing 212 includes a space that wafers W are cleaned. The first housing 212 includes an inner bath 212a and an outer bath 212b. The inner bath 212a is filled with a treating solution and provides a space in which wafers W are dipped during a cleaning process. The outer bath 212b surrounds a side surface of the inner bath 212a and accommodates a treating solution overflowing from the inner bath 212a. The first boat 214 supports wafers W inside the first housing 212 during a cleaning process. The first boat 214 supports a plurality of wafers W so that the wafers W are vertically placed. The first supply nozzle 216 receives a treating solution from the first supply line 218 and injects the treating solution to the wafers W placed in the first boat 214. The treating solution is a chemical solution for removing remaining foreign materials from a surface of wafer W.

Inside the inner bath 212a, the first boat 214 supports wafers W so that the wafers W are vertically placed during a cleaning process. In an embodiment, referring to FIG. 4, a first boat 214 includes a first supporting portion 214a and a second supporting portion 214b. The first and second supporting portions 214a and 214b have a bar shape and are in parallel to be spaced a predetermined distance apart from each other. A contact portions 214a′ and 214b′ that are in contact with a portion of an edge of a wafer W are formed on the respective first and second supporting portions 214a and 214b. The contact portions 214a′ and 214b′ include grooves in which a portion of an edge of a wafer W is inserted. A portion of an edge of a wafer W dipped in an inner bath 212a of a treating bath 210 is supported by being inserted in the contact portions 214a′ and 214b′ formed on the first and second supporting portions 214a and 214b.

The second treating bath 220 has roughly the same constitution as the first treating bath 210. That is, the second treating bath 220 includes a second housing 222, a second boat 224, a second injection nozzle 226 and a second supply line 228. A space which is filled with a treating solution is provided to inside the second housing 222. Inside the second housing 222, the second boat 224 supports wafers W. The second injection nozzle 226 receives a treating solution from the second supply line 228 and injects the treating solution into wafers W placed on the second boat 224 during a cleaning process.

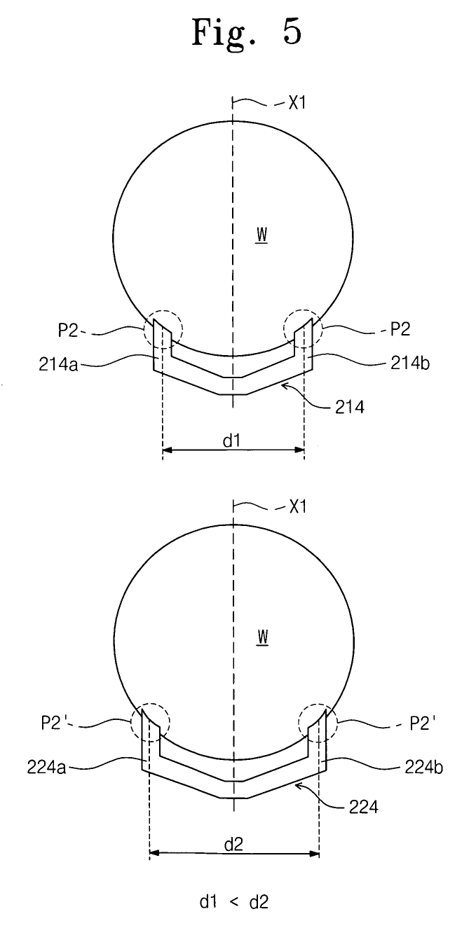

Each of the boats included in each of the treating baths 210, 220, 230, 240, 310, 320, 330 and 340 supports a different part of a wafer W during a cleaning process. A distance between the supporting portions of each of the boats is made different, so that each of the boats supports a wafer W by being in contact with different parts of a wafer W. Referring to FIG. 4, a distance d1 between the first supporting portion 214a and the second supporting portion 214b of the first boat 214 is greater than a distance d2 between the first supporting portion 224a and the second supporting portion 224b of the second boat 224. Thus, as shown in FIG. 5, contact points P1 and P2 that a wafer W is in contact with the first and second supporting portions 214a and 214b of the first treating bath 210 are different from contact points P1′ and P2′ that a wafer W is in contact with the first and second supporting portions 224a and 224b of the second treating bath 220.

In the above-described embodiment, a boat having two supporting portions was described. However, the number, a shape and a structure of the boat may be variously varied. For example, a boat according to another embodiment of the present invention includes three supporting members.

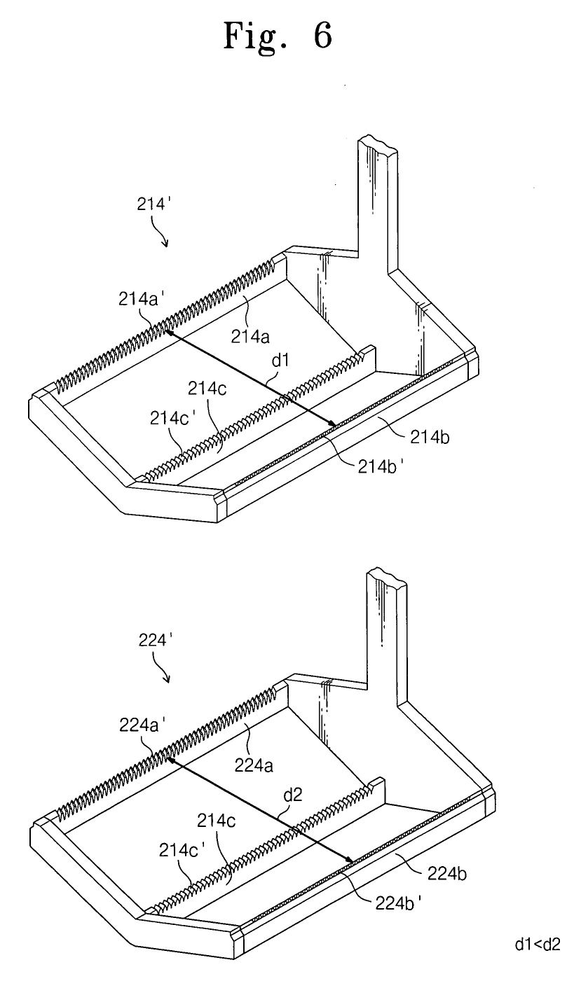

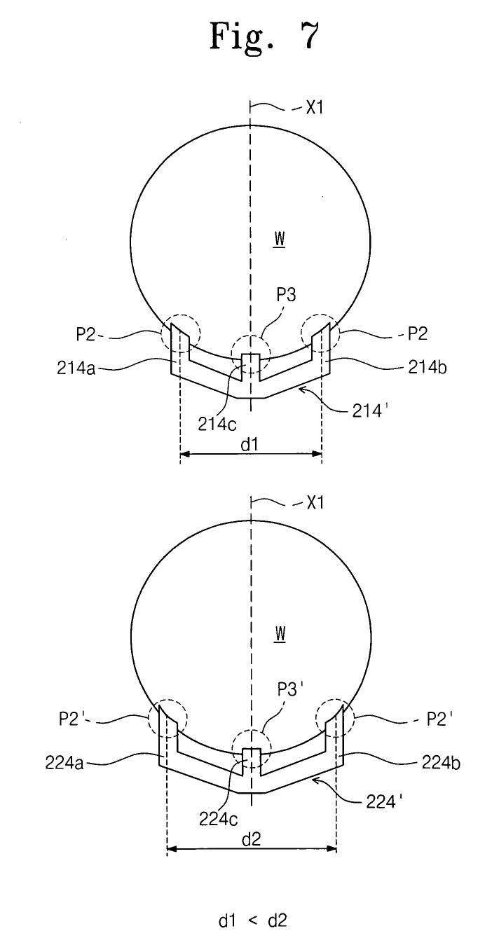

Referring to FIG. 6, a first boat 214′ of a first treating bath 210 in accordance with another embodiment includes first through third supporting portions 212a, 212b and 212c. The first supporting portion 212a and the second supporting portion 212b are bisymmetrically disposed with respect to the third supporting portion 212c. Heights of contact portions 212a′ and 212b′ of the first and second supporting portions 212a and 212b are greater than a height of a contact portion 212c′ of the supporting portion 212c. In the same manner, a second boat 224′ of the second treating bath 220 includes first through third supporting portions 224a, 224b and 224c. Each of the first through third supporting portions 224a, 224b and 224c has roughly the same structure as the first boat 214′ of the first treating member 210. A distance d2 between the first supporting portion 224a and the second supporting portion 224b of the second boat 224′ is greater than a distance d1 between the first supporting portion 214a and the second supporting portion 214b of the first boat 214′. As shown in FIG. 7, contact points P1, P2, and P3 that wafers W are in contact with the first through third supporting portions 214a, 214b and 214c of the first boat 214′ when the wafers W are cleaned in the first treating bath 210′ are different from contact points P1′, P2′ and P3′ that wafers W are in contact with the first through third supporting portions 224a, 224b and 224c of the second boat 224′ when the wafers W are cleaned in the second treating bath 220.

A wafer cleaning unit 40 having a boat according to another embodiment of the present invention includes more wafer supporting portions than the wafer cleaning unit 40 having a boat according to an embodiment. As a result, wafers W are supported in a more stable condition during a cleaning process.

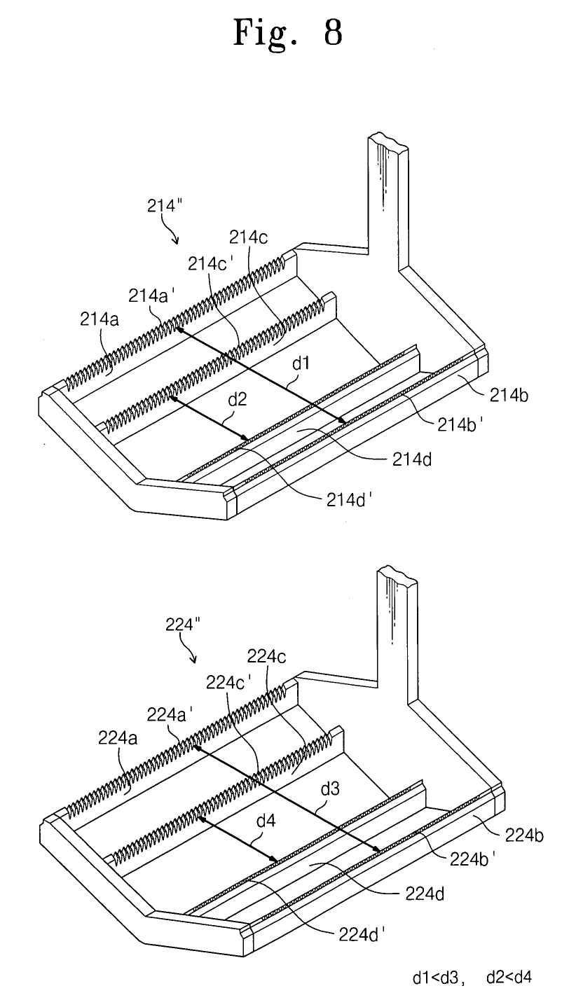

In still another embodiment, a boat includes four supporting portions. Referring to FIG. 8, a first boat 214″ of the first treating bath 210 includes first through fourth supporting portions 212a, 212b, 212c and 212d. The first supporting portion 212a and the second supporting portion 212b are bisymmetrically disposed with respect to a vertical line X1 vertically crossing a center of a wafer W placed on the first boat 214″. The third supporting portion 212c and the fourth supporting portion 212d are bisymmetrically disposed with respect to the vertical line X1 between the first supporting portion 212a and the second supporting portion 212b. Heights of contact portions 212a′ and 212b′ of the first and second supporting portions 212a and 212b are greater than heights of contact portions 212c′ and 212d′ of the third and fourth supporting portions 212c and 212d. A second boat 224″ of a second treating bath 220 includes first through fourth supporting portions 224a, 224b, 224c and 224d. Each of the first through fourth supporting portions 224a, 224b, 224c and 224d has roughly the same structure as the first boat 214″ of the first treating bath 210. A distance d3 between the first and second supporting portions 224a and 224b of the second boat 224″ is greater than a distance d1 between the first and second supporting portions 214a and 214b of the first boat 214″. Also, a distance d4 between the third and fourth supporting portions 224c and 224d of the second boat 224″ is greater than a distance d2 between the third and fourth supporting portions 214c and 214d of the first boat 214″.

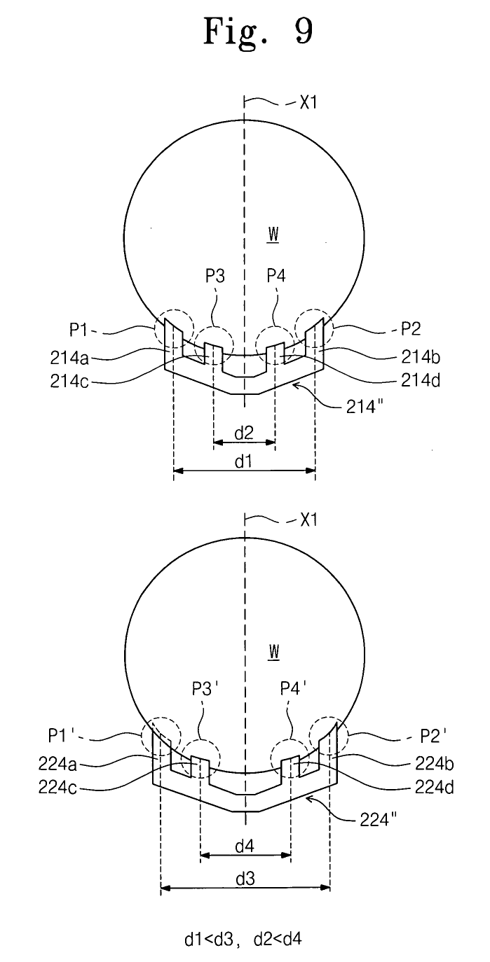

Thus, as shown in FIG. 9, contact points P1, P2, P3 and P4 that a wafer W is in contact with the first through fourth supporting portions 214a, 214b, 214c and 214d of the first boat 214″ are different from contact points P1′, P2′, P3′ and P4′ that a wafer W is in contact with the first through fourth supporting portions 224a, 224b, 224c and 224d of the second boat 224″ during a cleaning process.

The wafer cleaning unit having a boat according to still another embodiment includes more wafer supporting portions than the wafer cleaning unit having a boat according to another embodiment. As a result, wafers W are supported in a more stable condition during a cleaning process. A location of supporting portions of a boat included in each of treating baths is made different, so that the supporting portions of a boat included in each of treating baths are in contact with different points of a wafer W.

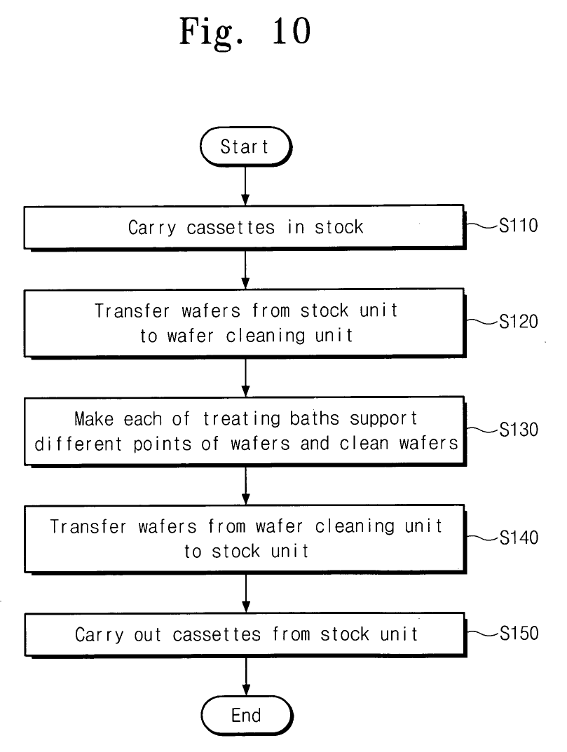

Referring to FIG. 10, a process for treating the substrate of the substrate treating apparatus is described in detail. FIG. 10 is a flow chart showing a method of treating a substrate according to the present invention. If a process for treating a substrate starts, cassettes C are carried in a stock unit (S110). That is, the cassette C receiving wafers W on which a cleaning process will be performed is carried in a cassette receiving portion 10 through a carrying in portion 12 of the cassette receiving portion 10. The cassette C carried in the carrying in portion 12 is two dimensionally arranged on a predetermined location of the cassette receiving portion 10 by a transfer arm 22 of a cassette transferring portion 20.

A first wafer transferring unit 30 carries out wafers W of the cassette C received from the transfer arm 22 of the cassette transferring portion 20 and then transfers the wafers W to a wafer cleaning unit 40 (S120). That is, a first robot arm 32 sequentially carries out wafers W of the cassette C received from the transfer arm 22 and then transfers the wafers W to a first arm 42b of the wafer cleaning unit 40.

The wafer cleaning unit 40 cleans the received wafers W (S130). That is, a first robot arm 110 of the transferring portion 100 dips the wafers W in the respective treating baths 210 of the first cleaning portion 200, so that remaining foreign materials are removed. A second robot arm 120 of the transferring portion 100 dips the wafers W in each of the treating baths 310 of the second cleaning portion 300, so that remaining foreign materials on the wafers W are removed. A description of the wafer cleaning process by the wafer cleaning unit 40 will be described later.

Wafers W of which a cleaning process is completed transfer to a cassette C in a cassette treating unit (S140). That is, wafers W of which a cleaning process is completed by a second cleaning unit 44 carries in a cassette C located at the cassette transferring portion 20 by a second arm 44b. A cassette C including wafers W of which a cleaning process is completed is carried out from the apparatus 1 by a carrying out portion 14 of a stock unit and transferred a facility in which a subsequent process is performed (S150).

Each of the treating baths supports different points of wafers W and cleans the wafers W while the wafer cleaning process is performed (S130). That is, a first robot arm 110 of the transferring portion 100 dips the wafers W in an inner bath 212 of a first treating bath 210. Wafers W dipped in the inner bath 212 of the first treating bath 210 are placed on a first boat 214. A portion of an edge of wafers W is supported by being inserted in grooves 214a′ and 214b′ formed on first and second supporting portions 214a and 214b of the first boat 214. If wafers W are placed on the first boat 214, a first injection nozzle 216 receives a treating solution from a first supplying member 218 and injects the first treating solution into wafers W placed on the first boat 214. Points P1 and P2 that a wafer W is in contact with the first and second supporting portions 214a and 214b are not completely cleaned by a first treating solution.

When a wafer W cleaning is completed in the first treating bath 210, a first robot arm 110 carries out the wafers W from the first treating bath 210 and dips the wafers W in an inner bath 222 of the second treating bath 220. Wafers W dipped in the second treating bath 220 are placed on a boat 224. Contact points P1′ and P2′ that a wafer W is in contact with the first and second supporting portions 224a and 224b of the second boat 224 are different from contact points P1 and P2 that a wafer W is in contact with the first and second supporting portions 214a and 214b of the first boat 214. When wafers W are placed on the second boat 224, a second injection nozzle 226 receives a treating solution from a second supply line 228 and injects the treating solution into the wafers W. A second treating solution supplied by the second supply line 228 of the second treating bath 220 may be different from a first treating solution supplied by a first supply line 218 of the first treating bath 210. Alternatively, the first treating solution may be the same as the second treating solution. The second treating solution injected by the second injection nozzle 226 removes remaining foreign materials on a surface of wafers W and also removes edge points P1 and P2 of wafers W which are not cleaned in the first treating bath 210.

When a wafer W cleaning is completed in the second treating bath 220, a first robot arm 110 sequentially dips wafers W in the third treating bath 230 and the fourth treating bath 240 and the third and fourth treating baths 230 and 240 clean the dipped wafers W. As shown in FIG. 3, a distance d3 between first and second supporting portions of the third boat 234 of the third treating bath 230 is different from a distance d4 between first and second supporting portions of the fourth boat 244 of the fourth treating bath 240. As a result, the third and fourth boats 234 and 244 are in contact with different points of edges of wafers W. Therefore, the first through fourth boats of the first through fourth treating baths 210, 220, 230 and 240 are in contact with different points of wafers W, respectively and a cleaning process is performed.

If a wafer W cleaning of a first cleaning portion 200 is completed, a wafer W cleaning of a second cleaning portion 300 is performed. That is, a second wafer transferring unit 50 transfers wafers W from the first cleaning portion 200 to the second cleaning portion 300. A second robot arm 120 sequentially dips wafers W in fifth through eighth treating baths 310, 320, 330 and 340 and the fifth through eighth treating baths 310, 320, 330 and 340 sequentially cleans wafers W. Distances between first and second supporting portions of boats of the fifth through eighth treating baths 310, 320, 330 and 340 are made different, so that the boats of the fifth through eighth treating baths 310, 320, 330 and 340 are in contact with different points of wafers W, respectively and a cleaning process is performed.

Wafers W that a cleaning process is completed are transferred to a cassette C of a cassette treating unit (S140). That is, wafers W of which a cleaning process is completed by a second cleaning unit 44 are carried in to a cassette C located at a cassette transferring portion 20 by a second arm 44b of a first wafer cleaning unit 42 (S140). Cassette C receiving wafers W that a cleaning process is completed is carried out from the apparatus 1 through a carrying out portion 14 of a stock unit and transfers to a facility that a subsequent process is performed (S150).

As described above, in the wafer cleaning unit and the substrate treating apparatus in accordance with the present invention, distances between the supporting portions of the boats of the treating baths are made different, so that the boats of the treating baths are in contact with different points of wafers W, respectively and a cleaning process is performed. Therefore, points on wafers W which are not cleaned because the points are in contact with a boat of any treating bath can be cleaned in different treating baths, thereby improving an efficiency of a cleaning process.

What is claimed is:

1. An apparatus for treating a substrate, comprising:
a first treating bath that includes a first housing having a space that is filled with a treating solution and a first supporting member that supports the substrate in the first housing during a process;
a second treating bath that includes a second housing having a space that is filled with a treating solution and a second supporting member that supports the substrate in the second housing during a process; and
a transferring portion that transfers the substrate to the first treating bath and the second treating bath, wherein the first supporting member and the second supporting member are shaped so that points that the first and second supporting members are in contact with the substrate are different during a process.

2. The apparatus of claim 1, wherein the first and second supporting members support the substrate so that the substrate is vertically placed inside of the housing during a process, wherein each of the first and second supporting members further comprises a first supporting portion and a second supporting portion that are in contact with a portion of an edge of the substrate, the first and second supporting portions being bisymmetrically disposed with respect to a vertical line vertically crossing a center of the substrate dipped inside of the housing, wherein a distance between the first supporting portion and the second supporting portion of the first supporting member is different from a distance between the first supporting portion and the second supporting portion of the second supporting member.

3. The apparatus of claim 2, wherein each of the first and second supporting portions has a contact portion that is in contact with the substrate during a process and wherein a height of the contact portion of the first supporting portion is the same as a height of the contact portion of the second supporting portion.

4. The apparatus of claim 1, wherein the first and second supporting members support the substrate so that the substrate is vertically placed inside of the housing during a process, wherein each of the first and second supporting members further comprises a first supporting portion, a second supporting portion and a third supporting portion that are in contact with a portion of an edge of the substrate, the first and second supporting portions being disposed on both sides with respect to the third supporting portion, wherein a distance between the first supporting portion and the second supporting portion of the first supporting member is different from a distance between the first supporting portion and the second supporting portion of the second supporting member.

5. The apparatus of claim 4, wherein each of the first to third supporting portions has a contact portion that is in contact with the substrate during a process, wherein a height of the contact portion of the first supporting portion is the same as a height of the contact portion of the second supporting portion, and wherein a height of the contact portion of the third supporting portion is lower than heights of the contact portions of the first and second supporting portions.

6. The apparatus of claim 5, wherein the first and second supporting portions are bisymmetrically shaped with respect to a vertical line vertically crossing a center of the substrate dipped inside of the housing during a process.

7. The apparatus of claim 1, wherein the first and second supporting members support the substrate so that the substrate is vertically placed inside of the housing during a process, wherein each of the first and second supporting members further comprises a first supporting portion, a second supporting portion, a third supporting portion and a fourth supporting portion that are in contact with a portion of an edge of the substrate, the first and second supporting portions being bisymmetrically disposed with respect to a vertical line vertically crossing a center of the substrate, the third and fourth supporting portions being bisymmetrically disposed with respect to a vertical line vertically crossing a center of the substrate and located between the first and second supporting portions, wherein a distance between the first supporting portion and the second supporting portion of the first supporting member is different from a distance between the first supporting portion and the second supporting portion of the second supporting member, and wherein a distance between the third supporting portion and the fourth supporting portion of the first supporting member is different from a distance between the third supporting portion and the fourth supporting portion of the second supporting member

8. The apparatus of claim 7, wherein the each of the first to fourth supporting portions has a contact portion that is in contact with the substrate during a process, wherein a height of the contact portion of the first supporting portion is the same as a height of the contact portion of the second supporting portion, wherein a height of the contact portion of the third supporting portion is the same as a height of the contact portion of the fourth supporting portion, and wherein heights of the contact portions of the first and second supporting portion are higher than heights of the contact portions of the third and fourth supporting portions.

9. The apparatus of claim 1, wherein the first treating bath and the second treating bath are adjacently disposed.

10. The apparatus of claim 1, wherein the first cleaning portion includes a supply line which supplies a first treating solution to the first housing and wherein the second cleaning portion includes a supply line which supplies a second treating solution different from the first treating solution to the second housing.

11. The apparatus of claim 1, wherein the first cleaning portion includes a supply line which supplies a first treating solution to the first housing and wherein the second cleaning portion includes a supply line which supplies the first treating solution to the second housing.

12. A method for treating a substrate, comprising:
dipping a substrate into a treating solution in a treating bath to clean the substrate, wherein at least two of the treating baths clean the substrate by supporting different points of the substrate dipped in the treating solution.

13. The method of claim 12, wherein the treating bath includes a plurality of housings which are filled with a treating solution and a supporting member which is provided to each of the housings and supports the substrate, and wherein supporting different points of the substrate is performed by making shapes of the supporting members different.

14. The method of claim 13, wherein the supporting member supports the substrate so that the substrate is vertically placed inside of the housing during a process, and wherein supporting different points of the substrate is performed by making a distance between a first supporting portion and a second supporting portion different at every treating bath, the first supporting portion being in contact with the one edge of the substrate with respect to a vertical line crossing a center of the substrate dipped in the housing and the second supporting portion being in contact with the other edge of the substrate with respect to the vertical line crossing a center of the substrate dipped in the housing.

15. The method of claim 12, wherein at least two treating baths clean the substrate using a different treating solution.

16. The method of claim 12, wherein at least two treating baths clean the substrate using the same treating solution.

17. The method of claim 12, wherein cleaning the substrate is performed by dipping the substrate that a cleaning process is just finished in any one treating bath in adjacent another treating bath.
